(19) United States
(12) Patent Application Publication
(10) Pub. No.: US 2025/0380828 A1
(43) Pub. Date: Dec. 18, 2025

(54) SANDWICH HOLDER

(71) Applicant: JEFFERY BARON LESPERANCE, HOWELL, MI (US)

(72) Inventor: JEFFERY BARON LESPERANCE, HOWELL, MI (US)

(21) Appl. No.: 19/195,823

(22) Filed: May 1, 2025

Related U.S. Application Data
(60) Provisional application No. 63/661,373, filed on Jun. 18, 2024.

(51) Int. Cl. A47G 21/00; B65D 81/38; G09F 23/08

(52) U.S. Cl. CPC A47G 21/001; B65D 81/3837; G09F 23/08

(57) ABSTRACT

A holder for a food product is provided. The holder encloses a food product and includes plungers to move the food product as well as securely store the food product within the holder. The plungers may include a handle to allow a user to move the food product as desired out of the holder to be consumed. The plunger may include a handle that engages a slot in the holder. The holder may include a flat base and/of one or more feet to allow the holder to be self-supporting. The feet may be integrated into the holder or be additional separate components. One or more logos may be included on the holder for advertising or informational purposes.

### CROSS-REFERENCE TO RELATED APPLICATIONS

This application claims priority benefit of U.S. Provisional Application No. 63/661,373 filed on Jun. 18, 2024, the entire contents and disclosures of which are incorporated herein by reference.

### BACKGROUND

Sandwiches and other foods are often portable. In other words, people desire to transport sandwiches and other foods from the place of creation (kitchen, etc.) to other places. Transporting sandwiches and other foods (e.g., hot dogs) often comes with a number of challenges.

Hot dogs, for example and without limitation, are often made and consumed in different places. While some hot dogs are consumed at home or in restaurants, even in those locations they are often transported from the place of preparation to a plate, a table, a server's tray, etc.

In other situations, hot dogs are made and consumed in different places. One such place is a sporting event. Often hot dogs and their related brethren (sausages, kielbasa, bratwursts, etc.) are sold to spectators at sporting events. There are several typical purchase situations for hot dogs at these events.

In one situation, a spectator travels from their seat to a concourse or other portion of the stadium and approaches a stationary food vendor. The spectator orders their hot dog and it is given to them, often with numerous toppings or condiments as is the current fashion. The spectator is then faced with a dilemma. They have to navigate from the food vendor through an often-crowded concourse back to their seat in the stadium. Also typically, the spectator acquires additional food and/or beverage items from the food vendor or en route to their seat. It can be challenging to carry food and/or drinks back to one's seat without dropping or damaging the food and/or drinks in the process, particularly with the typical hot dog holder.

In another situation, a guest at an amusement park decides to purchase a hot dog from a park vendor. The spectator receives their hot dog and then needs to decide if they will eat it immediately, find a table and a seat, a convenient trash can to eat off of, or walk and eat at the same time. Similarly to the stadium spectator, each choice is fraught with danger. The guest needs to travel in most cases at least several steps (often many more) to find a suitable place to consume their hot dog. Many amusement parks are very crowded, particularly near food vendors. The possibility of a collision is very high, resulting in the damage, or worse, the loss of the (likely) expensive amusement park hot dog, particularly with the typical hot dog holder.

In yet another situation, a customer purchases a hot dog from a restaurant. The restaurant could be a fast-food, fast-casual, or other more traditional restaurant. In any event, the hot dog is prepared in the restaurant kitchen and is then transported to the customer. During that transit, the hot dog may be handled and/or carried by one or more people, conveyors, robots, or a variety thereof. The potential for the hot dog to be damaged or destroyed exists. The hot dog, laden with toppings is ripe for damage, causing frustration for the customer and potential lost revenue for the restaurant if the hot dog needs to be remade to complete the customer's order. Of course, this situation exists for the previous examples as well, to varying degrees. Even after the customer receives their hot dog, they may still need to transport the hot dog intact before it is consumed, so the need to protect the hot dog after the sale continues.

In all the previous situations described, there is another continuing problem. The hot dog must be easily and safely consumed (or eaten). Hot dogs or other sandwiches, as described herein, are often challenging to eat, or to eat cleanly, without making a mess and/or losing many expensive toppings. Most hot dog holders are open trays that have been used for decades. These trays often struggle to keep a hot dog and its condiments stable during transport, and fail to make eating the hot dog an easy affair. Other “clam-shell” style holders offer more protection but still make it difficult to eat the hot dog due to the off-balance situation once the clam-shell is opened.

What is needed then is a different approach to a hot dog (or other sandwich or food item) holder that fully encloses the hot dog, allows for its safe and secure transport, and optionally allows for the user to eat the hot dog using only one hand.

### SUMMARY

The present disclosure overcomes the problems and disadvantages associated with current strategies and designs and provides new tools and methods for a hot dog/sandwich holder, also referred to herein as a sandwich container, tube, enclosure, or package.

A holder (or container) for a food product is provided. The holder encloses a food product and includes plungers to move the food product as well as securely store the food product within the holder. The plungers may include a handle to allow a user to move the food product as desired out of the holder to be consumed. The plunger may include a handle that engages a slot in the holder. The holder may include a flat base and/of one or more feet to allow the holder to be self-supporting. The feet may be integrated into the holder or be additional separate components. One or more logos may be included on the holder for advertising or informational purposes.

According to an embodiment of the disclosure, a holder for a food product is provided that includes a main body defining an internal cavity extending between a first opening and a second opening, a slot extending longitudinally along at least a portion of the main body, and a plunger moveably disposed within the internal cavity, the plunger including a handle configured to engage the slot and permit movement of the plunger within the internal cavity, where the sandwich holder is reclosable by repositioning the plunger within the internal cavity to cover a portion or all of the sandwich, and where at least one plunger is optionally secured to the main body via a retaining device.

According to an embodiment of the disclosure, a holder for a food product is provided that includes a main body that is cylindrical in shape.

According to an embodiment of the disclosure, a holder for a food product is provided that includes a main body that is formed of biodegradable material that includes at least one of molded pulp, paperboard, and bamboo fiber.

According to an embodiment of the disclosure, a holder for a food product is provided that includes a main body that is formed of a thermoplastic polymer that includes at least one of polyethylene, polypropylene, and polylactic acid (PLA).

According to an embodiment of the disclosure, a holder for a food product is provided that includes a plunger that frictionally engages the interior surface of the main body.

According to an embodiment of the disclosure, a holder for a food product is provided that includes a plunger that is removable from the main body to fully reclose the holder.

According to an embodiment of the disclosure, a holder for a food product is provided that includes reclosing the holder that comprises sliding the plunger back toward its original position at the first opening.

According to an embodiment of the disclosure, a holder for a food product is provided that includes a retaining device that comprises a flexible tether connecting the plunger to the main body.

According to an embodiment of the disclosure, a holder for a food product is provided that includes a retaining device that comprises a hinge integrally formed between the plunger and the main body.

According to an embodiment of the disclosure, a holder for a food product is provided that includes a retaining device that is configured to break or detach upon application of a predetermined force

According to an embodiment of the disclosure, a method of consuming a food product using a holder, the method includes inserting a sandwich into an internal cavity of a main body of the holder; positioning a plunger at a first opening of the main body to contact the sandwich; advancing the plunger through a slot along the main body to incrementally expose the sandwich for consumption; reclosing the holder by retracting the plunger to cover the sandwich within the internal cavity; and optionally securing the plunger to the main body using a retaining device.

According to an embodiment of the disclosure, a method may include retracting the plunger to reseal the sandwich within the holder after partial consumption.

According to an embodiment of the disclosure, the method may include reclosing includes repositioning the plunger at a first opening to enclose the sandwich.

According to an embodiment of the disclosure, the method may include an advancing step that is performed by sliding a handle attached to the plunger along the slot.

According to an embodiment of the disclosure, the method may include stabilizing the holder by deploying one or more feet integrated into the main body.

According to an embodiment of the disclosure, a holder for a food product is provided that includes a a main body defining an internal cavity and having opposed first and second openings, a longitudinal slot formed along the main body, a first plunger and a second plunger each configured to engage a respective opening, at least one plunger including a handle engaging the slot for movement within the cavity, where the sandwich holder is reclosable to reseal the sandwich after partial consumption, and wherein at least one plunger is optionally attached to the main body by a retaining device.

According to an embodiment of the disclosure, a holder for a food product is provided that includes at least one plunger that is configured to frictionally engage an opening to enable reclosing after use.

According to an embodiment of the disclosure, a holder for a food product is provided that includes a retaining device that comprises a flexible tether connecting the plunger to the main body.

According to an embodiment of the disclosure, a holder for a food product is provided that includes a slot that includes variable-width portions to allow locking engagement with the handle.

According to an embodiment of the disclosure, a holder for a food product is provided that includes main body that further comprises an insulation layer to retain the temperature of the sandwich.

Other embodiments and advantages of the disclosure are set forth in part in the description, which follows, and in part, may be obvious from this description, or may be learned from the practice of the disclosure.

### BRIEF DESCRIPTION OF DRAWINGS

The disclosure is described in greater detail by way of example only and with reference to the attached drawings, in which:

FIG. 1 is a perspective view of an embodiment of the present disclosure;

FIG. 2 is a perspective view of an embodiment of the present disclosure;

FIG. 3 is a first side view of an embodiment of the present disclosure;

FIG. 4 is a second side view of an embodiment of the present disclosure;

FIG. 5 is a perspective view of an embodiment of the present disclosure;

FIG. 6 is a perspective view of an embodiment of the present disclosure;

FIG. 7 is a perspective view of an embodiment of the present disclosure;

FIG. 8 is a perspective view of an embodiment of the present disclosure;

FIG. 9 is a perspective view of an embodiment of the present disclosure;

FIG. 10 is a perspective view of an embodiment of the present disclosure;

FIG. 11 is a perspective view of an embodiment of the present disclosure; and

FIG. 12 is a cross-sectional view of an embodiment of the present disclosure.

### DETAILED DESCRIPTION

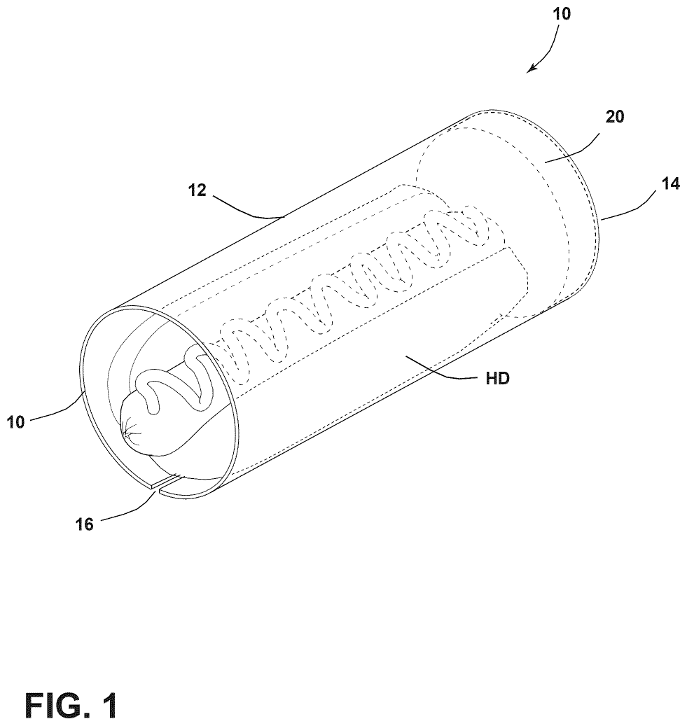

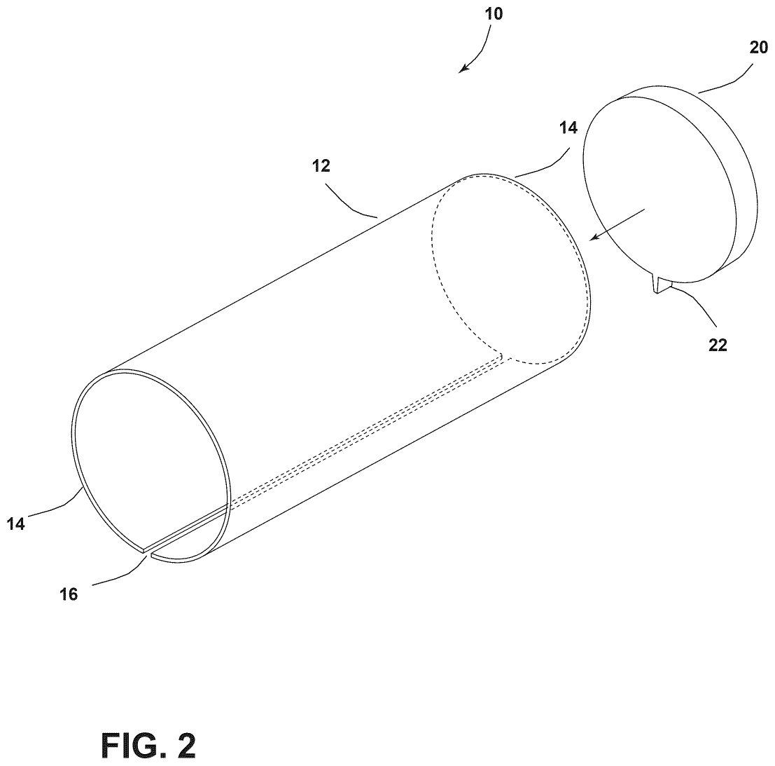

According to one embodiment of the present disclosure, a sandwich holder 10 is shown in FIG. 1. Holder 10 includes a main body 12. Main body 12 may be formed in a cylinder, as is shown in FIG. 1, or in a plurality of other shapes. It should be understood that the embodiment shown in FIG. 1 is only exemplary, and not limiting in nature.

Although the examples provided herein reference hot dogs for ease of illustration, it should be understood that the holder 10 may be adapted for use with a wide variety of food items. These may include, but are not limited to, sausages, brats, kielbasa, meat or vegetarian wraps, churros, egg rolls, taquitos, stuffed breadsticks, spring rolls, submarines, hoagies, or any elongated or portable food item both known and unknown that benefits from controlled dispensing and spill prevention.

Main body 12 may be formed in a variety of lengths, to provide an enclosure for a variety of foods. For example, a typical hot dog HD is about 6 inches (15.25 cm) in length, and the hot dog bun typically extends a portion beyond-so one embodiment of the main body 12 would be an enclosure that is approximately 7 inches (17.78 cm) long. Main body 12 may be formed in a cylindrical shape as shown in FIG. 1, with openings 14 at either end of the main body 12.

Main body 12 may be formed of a variety of materials, including but not limited to, paper, recycled paper, natural fiber, natural wood (e.g., bamboo), synthetic materials, or a combination thereof. Additionally, main body 12 (and other components of holder 10) may be constructed of suitable materials known and heretofore unknown that may be applicable for use in constructing holder 10 and/or its related components. In other embodiments, holder 10 and its separate components may be formed of composite materials which may provide desirable attributes to holder 10 and/or its components.

In other embodiments described herein, main body 12 may be formed as a cylinder with selectively deployable stabilizing feet 26 distributed about at least a portion of the main body 12. A user of the holder 10 may then deploy the feet 26 to prevent the holder 10 from rolling.

Returning to FIG. 1, main body 12 may include a slot 16. Slot 16 may be disposed along the centerline of the main body 12, in this embodiment, shown as a cylinder. Slot 16 may extend from one opening 14 to the other in main body 12, or slot 16 may be abbreviated and not run from one opening 14 of the main body 12 to the other opening 14. Slot 16 may be configured with a uniform dimension (e.g., 0.1 in/2.54 cm) throughout its length in main body 12. In other embodiments, slot 16 may be configured with more than one dimension, such as to provide locking or other physical engagement with one or more components of holder 10.

Holder 10 may also be configured with plungers 20. Plungers 20 may be configured to selectively and/or frictionally engage one or both openings 14 of main body 12. Plungers 20 may be configured to seal an opening 14 of main body 12.

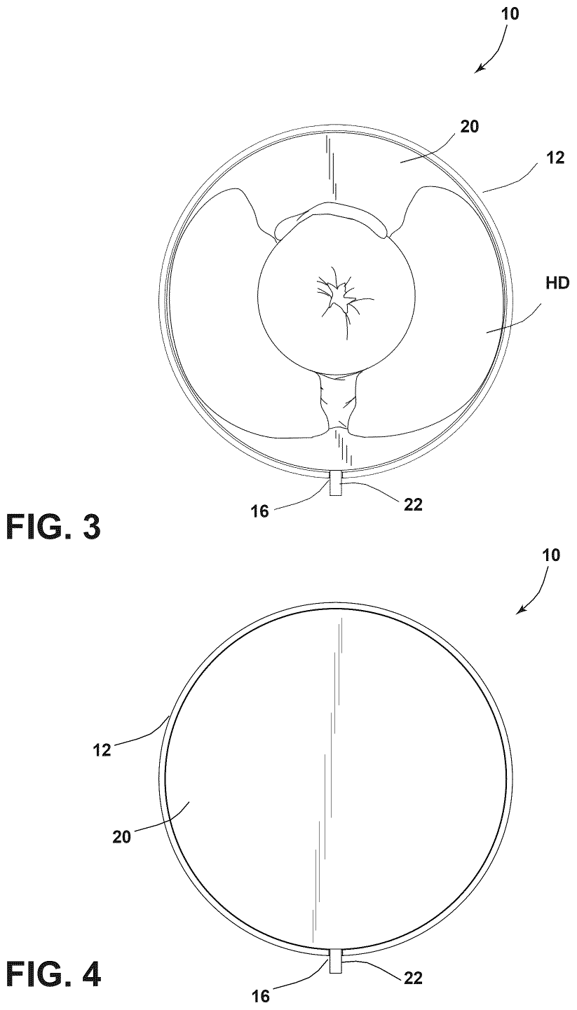

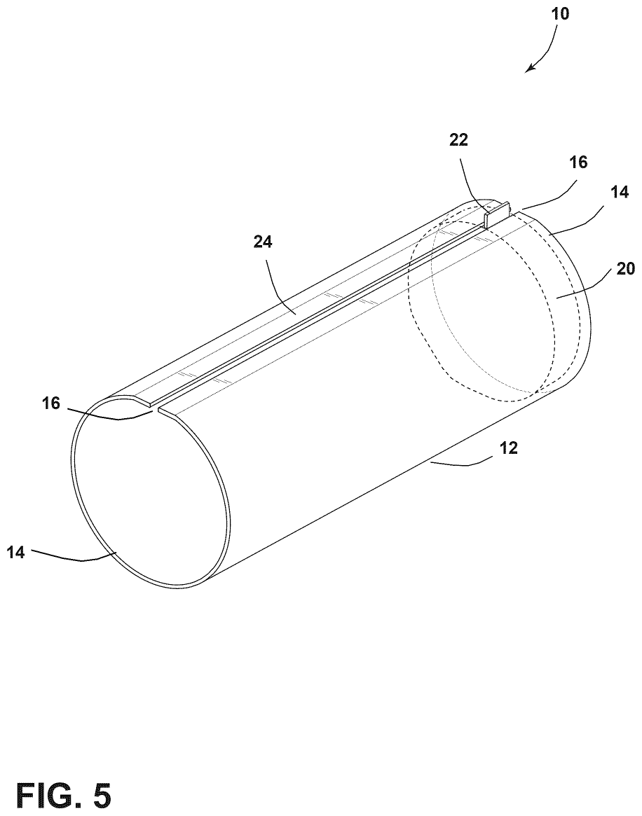

For example, a first plunger 20 may installed on the first opening 14 of main body 12 and a second plunger 20 may be installed on the opposite end opening 14 of main body 12, as shown in FIGS. 3-4.

Main body 12 may include plunger 20 positioned at one opening 14 of main body 12. A hot dog, fully prepared and complete with toppings, may be slid into holder 10 such that one end of the hot dog engages the plunger 20, leaving the hot dog fully enclosed within the holder. A second plunger 20 may be applied to the opposite end of the main body 12, sealing the hot hog within the holder 10 and allowing for the safe transport and consumption of the hot dog or other food item contained within.

Plunger 20 may include an optional handle 22 that may be disposed about the circumference of the plunger 20. Handle 22 may be formed of the same material as plunger 20 or a different material. In embodiments, handle 22 may be selectively deployable. In other words, handle 22 may be folded over against the circumference of plunger 20 and selectively deployed, or folded out, by a user when the user desires to use the handle 20. In additional embodiments, handle 22 may be removable, replaceable, or interchangeable. Handle 22 may be configured to provide stability to holder 10. Handle 22 may be configured in a “pistol grip” shape, for example and without limitation.

In alternative embodiments, the slot 16 may be replaced or supplemented by functionally equivalent guiding features, including recessed channels, rail and tab structures, or flexible guide sheaths. Similarly, handle 22 may be replaced by an integrated rib, loop, or push-tab element that facilitates user engagement and advancement of plunger 20.

Handle 22 of plunger 20 is configured to selectively engage slot 16 of the main body 12. By placing plunger 20 into one opening 14 of main body 12 such that handle 22 engages slot 16, a user may then use handle 22 to move plunger 20 within the interior of main body 12 from one opening 16 through to the other opening 16 on the opposite end of main body 12. Due to the possibility of a frictional fit between plunger 20 and the interior of main body 12, the handle 22 of plunger 20 may allow a user to gradually move plunger 20 within main body 12 to a desired position.

If a hot dog (or other food item) is contained within holder 10, the user's movement of the plunger 20 via the handle 22 (or without handle 22 by pushing on the plunger 20) will cause the hot dog to move within the main body 12 and begin to emerge from the opposite opening 14. In this way, the user may then take a bite of the hot dog while the remainder of the hot dog is still contained and/or protected within the main body 12 of the holder 10. As the user consumes the hot dog, movement of the plunger 20 or the combination of the plunger 20 and the handle 22 allows the user to gradually expose the remainder of the hot dog for consumption.

A user may choose to grasp the holder 10 with one hand and manipulate the plunger 20 or the plunger 20/handle 22 combination with a single hand, sliding the handle and grasping the exterior of the main body at the same time, exposing a portion of the hot dog to be consumed. Alternatively, a user may grasp the exterior of the main body 12 with one hand, and use their other hand to push the plunger 20 or the combination of plunger 20 and handle 22 with the other hand, slowly exposing the hot dog to be consumed as desired by the user.

If the user decides to pause or stop eating the hot dog contained in the holder 10, the user may move the plunger 20 back by grasping a portion of the plunger 20 and/or the handle 22 (if so equipped) and move the plunger 20 and/or plunger 20 with handle 22 back to the initially engaging opening 14 of the main body 12. A user may then place a second plunger 20 on the opposite opening 14 of main body 12 to seal the hot dog within the holder 10. In this way, plunger 20 may act as a “cap” for transport after initial preparation as well as a means for moving the hot dog within the main body 12 when the user decides to consumer some or all of the hot dog.

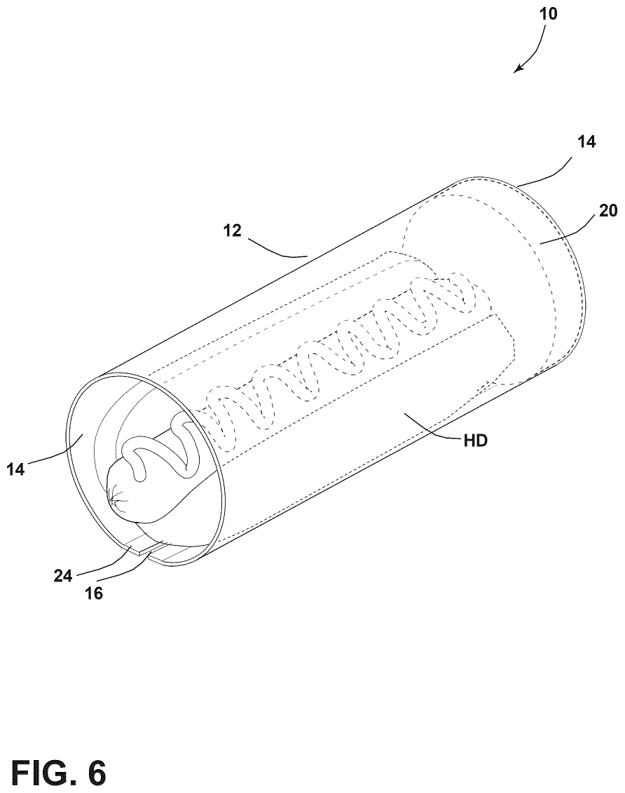

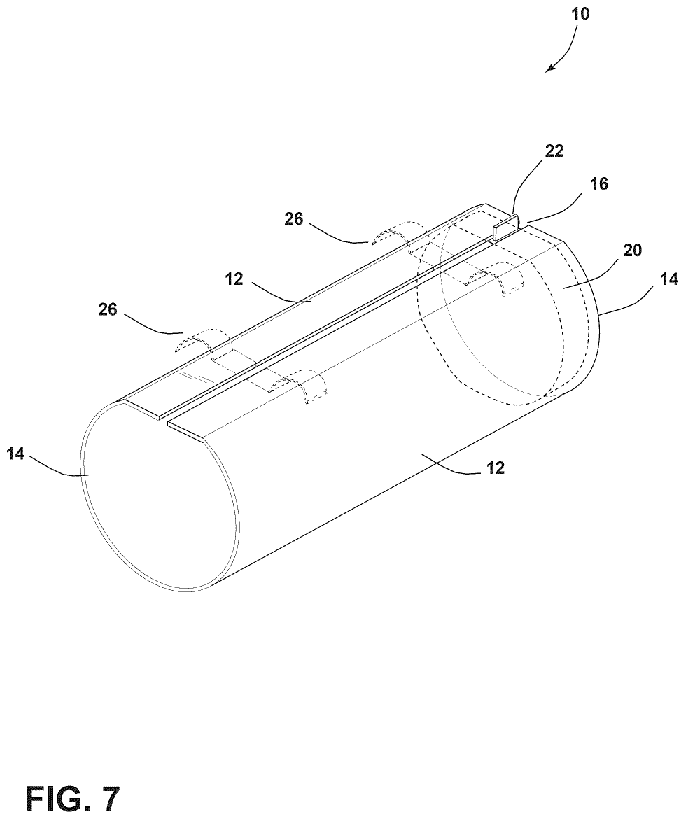

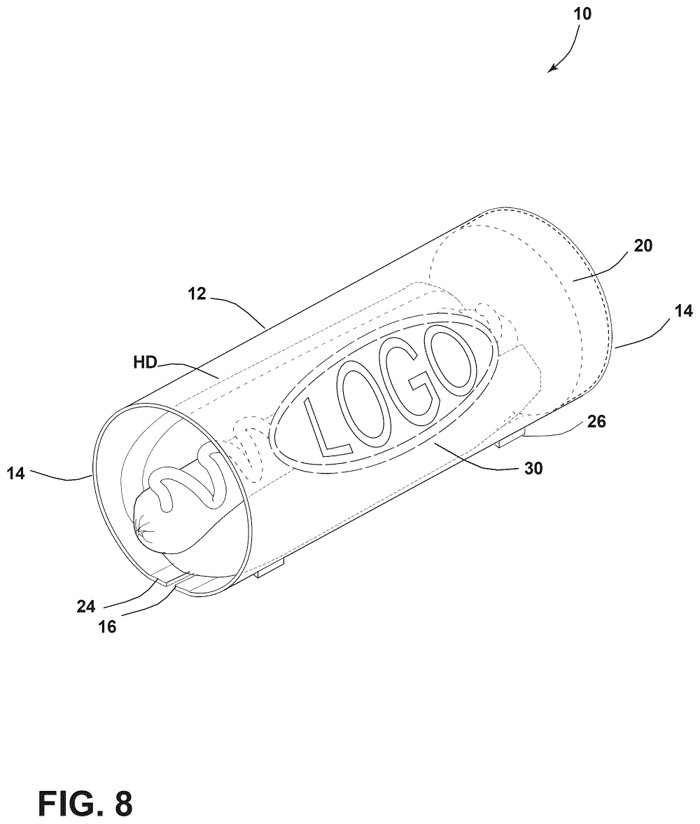

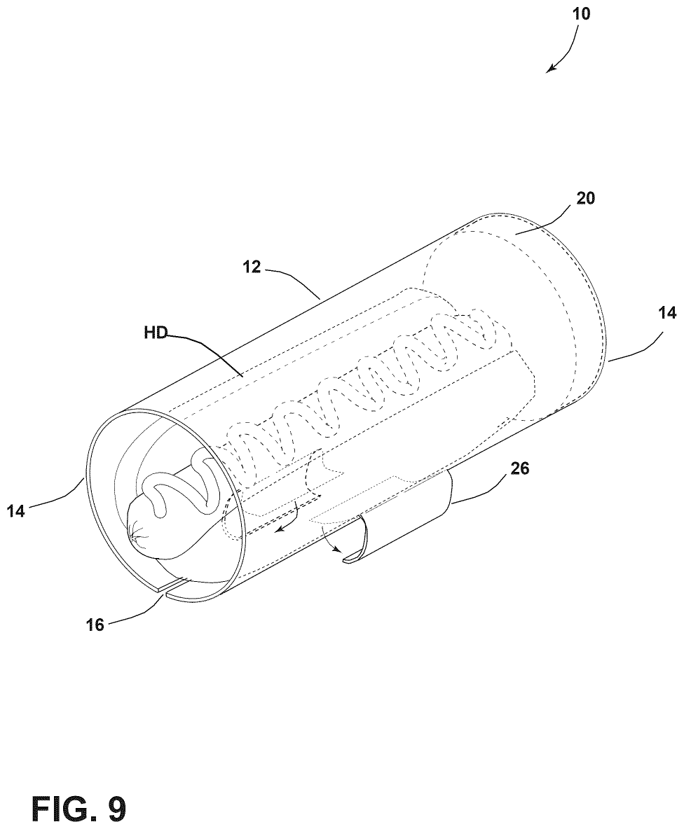

In another embodiment, the holder 10 may include one or more surface or element-base 24. Base 24 may be disposed on various places on the main body 12. Referring now to FIGS. 6-8, base 24 is shown disposed on main body 12 adjacent to slot 16. If holder 10 is formed from a cylindrical shape (though other shapes are contemplated and the present example should not be interpreted as limiting), due to the nature of a cylinder when placed on a surface to roll, one or more bases 24 disposed on the main body 12 of holder 10 acts to prevent the holder 10 from rolling. This is advantageous because the sandwich, for example a hot dog, contained within the holder 10 may become damaged or otherwise disturbed.

In addition, one or more feet 26 may be disposed on main body 12 of holder 10. The feet 26 may be integrated into main body 12. For example, the main body 12 may be formed of a cylindrical multi-layer paper or fiber tube. Feet 26 may be cut into layers of the tube of main body 12 such that when desired, the feet 26 may be pulled out or otherwise deployed by a user, or left incorporated into the surface of main body 12. In this way, holder 10 may be more simply manufactured and shipped as well as stored than if holder 10 required additional feet 26 as add-on components. Integrated feet as disclosed herein offer other benefits, including reduced manufacturing costs, reduced part count, and improved hygiene. It is contemplated that feet 26 may be modified or customized for specific events/situations, such as brand promotions, and event-specific designs (e.g., championship game).

In other embodiments, however, it is contemplated that feet 26 may be add-on

components to holder 10. For example, customized feet 26 may be themed or patterned after human or animal feet, may be part of a promotional event, etc.

In other embodiments of holder 10, a logo 30 may be included on the main body 12. The logo 30 may be stamped, molded, printed, adhered, or otherwise integrated into main body 12 of holder 10. For example, at a sporting event, a team logo 30 may be integrated on main body 12. In other embodiments, a logo 30 representing the vendor selling a food item using the holder 10 may include their logo 30. In other embodiments, multiple logos 30 may be placed on main body 12 or other components of the holder 10, such as but not limited to the slot 16, plungers 20, the handle 22, or the feet 26 or any combination thereof. In addition, advertising may be included using one or more logos 30.

As disclosed herein, main body 12 may be dimensioned in a variety of lengths, widths, and diameters to accommodate different types of sandwiches, hot dogs, sausages, and other foods. A typical hot dog HD is about 6 inches (15.25 cm) in length, with a bun extending slightly beyond each end. Accordingly, in one embodiment, the main body 12 is approximately 7 inches (17.78 cm) long to fully enclose the hot dog and bun. In other embodiments, the main body 12 may be shorter, e.g., 5 inches (12.7 cm) for cocktail hot dogs, or longer, e.g., 9-12 inches (22.86-30.48 cm) for footlong hot dogs or submarine sandwiches. The internal diameter or width of the main body 12 may similarly be adjusted to snugly or loosely fit the selected food product, with optional internal ridges, cushions, or liners for holding delicate toppings in place during transport.

The main body 12 may be constructed from a wide variety of materials depending on desired use cases. Suitable materials include, but are not limited to, paper, recycled paperboard, molded pulp, cardboard, natural fibers such as bamboo or hemp, biodegradable plastics, compostable polymers, traditional thermoplastics (e.g., polyethylene, polypropylene, PET), silicone rubber, or composites thereof. In embodiments designed for disposable use, paper or biodegradable materials may be preferred for cost and sustainability reasons. For reusable versions, synthetic polymers, silicones, or durable composites could be used to withstand multiple washings and extended use. Surface treatments such as waterproof coatings, antimicrobial additives, or slip-resistant texturing may be optionally applied to the inner and/or outer surfaces of the main body 12 to enhance usability, hygiene, and safety. For example, main body 12 may be constructed of molded pulp for stadium concessions due to its low cost and compostability.

In further embodiments, the main body 12 may incorporate additional functional features, such as thermal insulation layers to keep the sandwich warm, or ventilation openings or micro-perforations to allow moisture release and prevent sogginess. The body may be produced using various manufacturing processes including but not limited to extrusion, blow molding, vacuum forming, paper molding, additive manufacturing (3D printing), or injection molding, depending on the selected material and desired production scale.

Stabilization of the holder 10 is important to ensure ease of use. Therefore, in some embodiments, the main body 12 may include one or more integrated or deployable stabilizing feet 26 distributed about at least a portion of the main body 12. The feet 26 may be selectively deployed by the user to prevent the holder 10 from rolling when placed on a flat surface. In one design, the feet 26 are thin tabs formed from the same material as the main body 12, cut partway into the surface and bent outward when needed. In another design, small molded or affixed pads may provide permanent stabilization.

Turning to the internal structure, the main body 12 may include a longitudinal slot 16 extending along at least a portion of its length. In the embodiment of FIG. 1, the slot 16 is located along the centerline of the main body 12 and extends continuously from one opening 14 to the opposite opening 14. In alternate embodiments, the slot 16 may only partially extend along the body length, or include sections of different widths, keyhole shapes, or locking tabs designed to interact with a plunger handle. The slot width may be uniform (e.g., 0.1 inches (2.54 mm)), or variable to accommodate different operational features such as selective locking positions or indexing markers.

The holder 10 may be further configured with one or more plungers 20, each shaped and dimensioned to selectively and/or frictionally engage one or both openings 14 of the main body 12. The plungers 20 may be formed as circular or correspondingly shaped end caps, providing a friction-fit, snap-fit, threaded engagement, or even magnetic engagement with the openings 14. One embodiment includes a first plunger 20 installed into the first opening 14, and a second plunger 20 installed into the second opening 14, sealing the food product securely within the main body 12.

Each plunger 20 may include an integral or attached handle 22, configured to engage the slot 16 and allow the plunger 20 to be moved axially within the main body 12. The handle 22 may be foldable, telescoping, pivotable, or even retractable into the plunger 20 body for compact storage. In one embodiment, the handle 22 is a flexible strap that nests flush against the plunger and can be lifted by the user when needed. In another embodiment, the handle 22 is a rigid, molded tab designed to track along the slot 16, minimizing lateral movement while allowing easy linear advancement.

In use, a fully prepared hot dog or sandwich is placed into the main body 12 until one end engages the stationary plunger 20 positioned at one opening 14. The second plunger 20 is inserted into the opposite opening 14 to completely enclose the sandwich. By manipulating the handle 22 (or the plunger body itself if no handle is present), the user can slide the plunger 20 within the main body 12, gradually urging the sandwich outward through the opening 14 for consumption. This allows a user to consume the sandwich incrementally while maintaining the remainder securely contained within the holder, reducing the risk of spills or dropped toppings.

The user may manipulate the plunger 20 and the main body 12 with a single hand, sliding the handle 22 with thumb or fingers while gripping the exterior of the main body 12. Alternatively, the user may use two hands: one to hold the body 12 steady, and one to advance the plunger 20 as desired. If the user wishes to pause consumption, the plunger 20 can be retracted to reseal the food within the holder 10, and optionally capped with the second plunger 20 for temporary storage or transport.

The holder 10 further includes one or more plungers 20, each configured to move within the internal cavity. Each plunger 20 includes a handle 22, configured to engage and track within the slot 16. The plungers 20 may frictionally engage the internal surface of the main body 12 to maintain a desired position during use. In certain embodiments, the plunger 20 includes features such as selectively foldable handles, telescoping handles, or locking detents to facilitate smooth movement and user control.

During use, a food product is inserted into the internal cavity through an opening 14, and the plunger 20 is advanced to contact the food product. As the user desires to consume the food product, the plunger 20 may be advanced incrementally along the slot 16, exposing a portion of the food product while the remainder remains protected within the main body 12. The user may operate the plunger 20 and main body 12 with a single hand, sliding the handle 22 while gripping the main body 12, or may use two hands for greater control.

Importantly, the holder 10 is reclosable. After partial consumption of the food product, for example, and without limitation, the plunger 20 may be retracted toward the first opening 14 to reseal the internal cavity, preserving the remainder of the food product for later consumption or transport. In some embodiments, a second plunger 20 may be disposed at the second opening 14, enabling full enclosure of the food product within the holder 10 when both ends are sealed. It should be understood that the retaining device 28 may be substituted with any equivalent mechanism that allows selective retention or tethering of the plunger 20 while permitting movement for cleaning, replacement, or repositioning. Such equivalents may include loop-and-strap systems, retractable cords, or magnetic tethers.

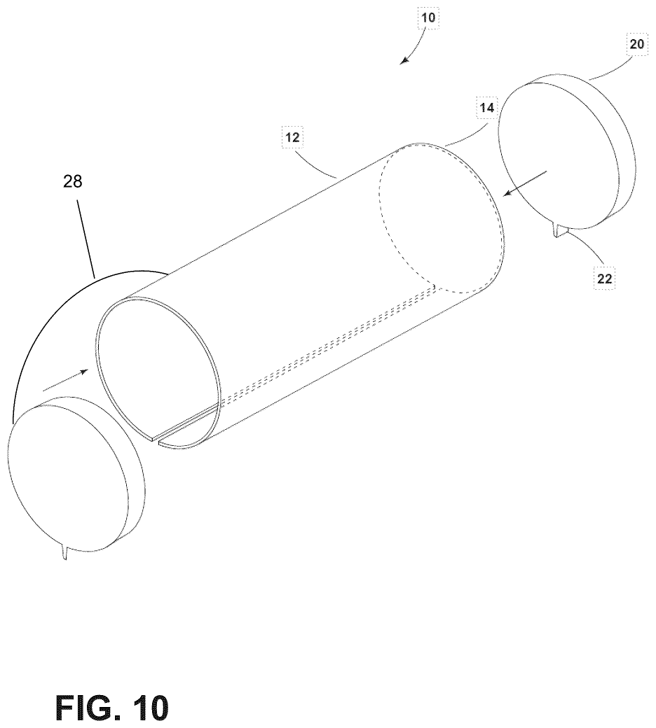

To enhance functionality, at least one plunger 20 may be optionally secured to the main body 12 via a retaining device 28. In some embodiments, the retaining device 28 may be a flexible tether connecting the plunger 20 to the main body 12. In other embodiments, the retaining device may be a hinge integrally formed between the plunger and the main body. In further embodiments, the retaining device may be a breakaway connection, configured to detach if a predetermined force threshold is exceeded, thereby allowing intentional detachment while normally preventing accidental loss of the plunger. The retaining device 28 shown in FIG. 10 is only exemplary, and not limiting.

In some embodiments, the components of the holder 10 may be modular and interchangeable. For example, plungers 20 may be interchanged based on food type, handle design, or retention preference. A user may select from a set of plunger types, handles, or retaining devices based on specific use scenarios, such as outdoor dining, children's use, or promotional events. Such modularity allows for customization and replacement of worn or soiled parts.

In another embodiment, the sandwich holder 10 may be provided as part of a kit. The kit may include a main body 12, one or more plungers 20, interchangeable handles 22, decorative stickers or labeling elements, and optional components such as detachable feet 26 or advertising inserts. In some embodiments, the kit may be packaged for consumer assembly or distributed for commercial use with customization options available for branding, event theming, or dietary labeling.

Additionally, the holder 10 may include decorative, promotional, or informational elements such as logos 30 molded, printed, embossed, adhered, or etched onto the main body 12, the plungers 20, the handles 22, or stabilizing feet 26. For example, a team logo may be imprinted on holders sold at a sporting event, or a restaurant brand logo may be included on holders used for takeout orders. Further, the holder 10 may be customizable, allowing identification to be included on the logo 30. For example, marking holder 10 to identify the contents, or the name of the consumer.

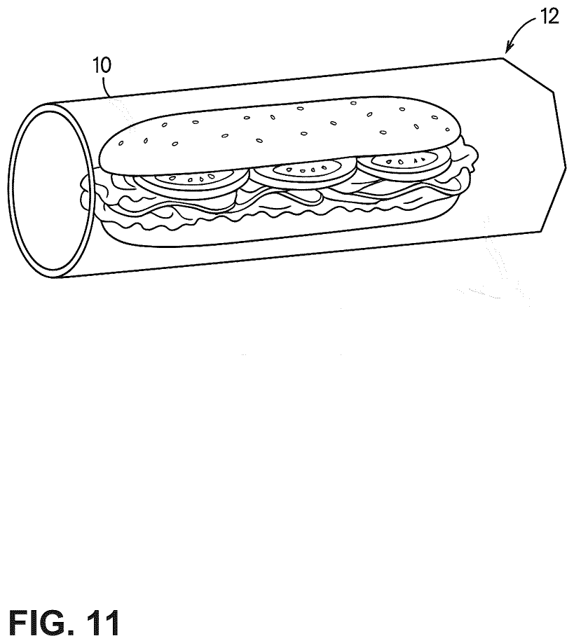

While holder 10 is shown in cylindrical form, it is contemplated that holder 10 may be constructed of other geometric shapes, or combinations thereof. For example and without limitation, holder 10 may be formed in a square, rectangular, oval, pentagon, or other polygon, or combinations thereof. It should be appreciated that any cross-sectional geometry or customized ergonomic shape can be used without departing from the spirit of the disclosure. The form may be optimized for grip comfort, stacking efficiency, manufacturing cost, brand identity, or thematic purposes. The present example therefore, is only exemplary and not limiting. Referring to FIG. 11, the holder 10 is shown, in one non-limiting embodiment, with a first geometric shape, a cylinder at one end, and a polygon shape at the other end of holder 10, such that holder 10 transitions from one shape, or profile across the length of holder 10, and a sandwich is situated safely within holder 10.

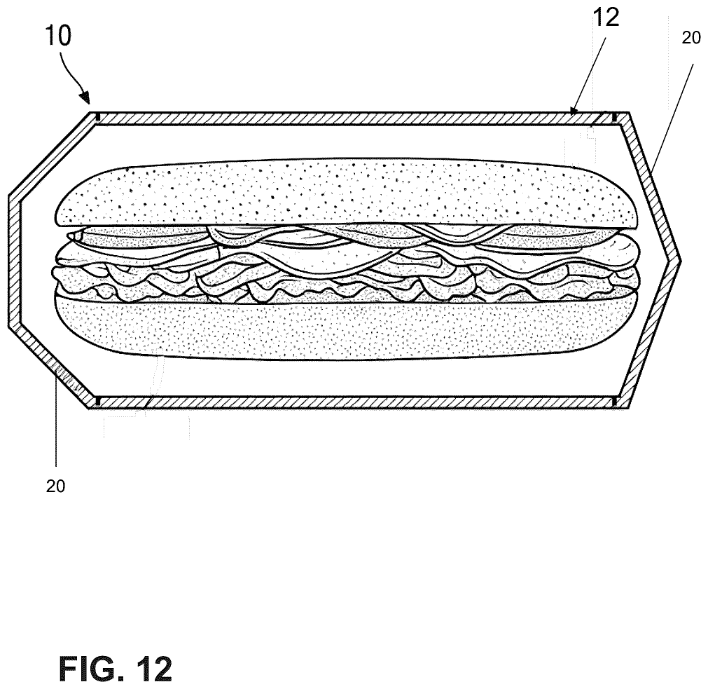

For example, FIG. 12 illustrates a cross-sectional view of embodiments of the disclosure. On one end is a holder 10 with a 3-sided profile (or a 6-sided profile), and the other end is a 2-sided profile (or a 4-sided profile). A sandwich is shown securely stored/protected inside holder 10. It should be understood that the holder 10 in this embodiment may include plungers 20 that match the respective profile, contrast the respective profile, or a combination thereof. In embodiments, the plungers 20 may not include the ability to move the sandwich, in this example, by sliding. In embodiments, the user may be required to move the sandwich out of the holder 10 by various means.

The preceding examples illustrate embodiments of the disclosure, but should not be viewed as limiting the scope of the disclosure.

Other embodiments and uses of the disclosure will be apparent to those skilled in the art from consideration of the specification and practice of the disclosure disclosed herein. All references cited herein, including all publications, U.S. and foreign patents and patent applications, are specifically and entirely incorporated by reference. The term comprising, where ever used, is intended to include the terms consisting and consisting essentially of. Furthermore, the terms comprising, including, and containing are not intended to be limiting. It is intended that the specification and examples be considered exemplary only with the true scope and spirit of the disclosure indicated by the claims.

1. A sandwich holder comprising:
a main body defining an internal cavity extending between a first opening and a second opening;
a slot extending longitudinally along at least a portion of the main body; and
a plunger moveably disposed within the internal cavity, the plunger including a handle configured to engage the slot and permit movement of the plunger within the internal cavity;
wherein the sandwich holder is reclosable by repositioning the plunger within the internal cavity to cover a portion or all of the sandwich; and
wherein at least one plunger is optionally secured to the main body via a retaining device.

2. The sandwich holder of claim 1, wherein the main body is formed of biodegradable or thermoplastic material.

3. The sandwich holder of claim 1, wherein the plunger frictionally engages the interior surface of the main body.

4. The sandwich holder of claim 1, wherein the retaining device comprises a tether, hinge, or breakaway mechanism.

5. The sandwich holder of claim 1, wherein the plunger is removable from the main body to fully reclose the holder.

6. The sandwich holder of claim 1, wherein reclosing comprises sliding the plunger back toward the first opening.

7. The sandwich holder of claim 1, wherein the slot includes variable-width sections for locking the plunger.

8. The sandwich holder of claim 1, further comprising a handle that is interchangeable or removable.

9. The sandwich holder of claim 1, wherein the slot comprises a guiding channel selected from recessed rails, grooves, or sheaths.

10. The sandwich holder of claim 1, further comprising stabilizing feet integrated into the main body.

11. A method of consuming a sandwich using a holder, the method comprising:
inserting a sandwich into an internal cavity of a main body of the holder;
positioning a plunger at a first opening of the main body to contact the sandwich;
advancing the plunger through a slot along the main body to incrementally expose the sandwich for consumption;
reclosing the holder by retracting the plunger to cover the sandwich within the internal cavity; and
optionally securing the plunger to the main body using a retaining device.

12. The method of claim 11, wherein the advancing step is performed by sliding a handle attached to the plunger along the slot.

13. The method of claim 11, further comprising retracting the plunger to reseal the sandwich within the holder after partial consumption.

14. The method of claim 11, further comprising stabilizing the holder by deploying one or more feet.

15. A system for transporting and consuming a sandwich, comprising:
a sandwich holder including a main body defining an internal cavity and having opposed first and second openings;
a longitudinal slot formed along the main body;
a first plunger and a second plunger each configured to engage a respective opening;
at least one plunger including a handle engaging the slot for movement within the cavity;
wherein the sandwich holder is reclosable to reseal the sandwich after partial consumption; and
wherein at least one plunger is optionally attached to the main body by a retaining device.

16. The system of claim 15, wherein each plunger is configured to frictionally engage an opening.

17. The system of claim 15, wherein the retaining device comprises a tether, hinge, or breakaway feature.

18. The system of claim 15, wherein the slot or guide mechanism includes a locking interface for the handle.

19. The system of claim 15, wherein the handle is configured to engage a modular or interchangeable guide interface.

20. The system of claim 15, wherein the main body further comprises an insulation layer to retain the temperature of the sandwich.
